(19) United States
(12) Patent Application Publication
(10) Pub. No.: US 2013/0275140 A1
(43) Pub. Date: Oct. 17, 2013

(54) METHOD AND APPARATUS FOR PROCESSING AUDIO SIGNALS AT LOW COMPLEXITY

(71) Applicant: SAMSUNG ELECTRONICS CO., LTD., Suwon-si (KR)

(72) Inventors: Mi-young KIM, Hwaseong-si (KR); Anton Viktorovich POROV, Saint-Petersburg (RU); Konstantin Sergeevich OSIPOV, Saint-Petersburg (RU)

(21) Appl. No.: 13/758,054

(22) Filed: Feb. 4, 2013

Related U.S. Application Data
(60) Provisional application No. 61/595,760, filed on Feb. 7, 2012.

(30) Foreign Application Priority Data
Feb. 2, 2012 (RU) 2012103446

(51) Int. Cl. G10L 19/002

(52) U.S. Cl. CPC G10L 19/002
USPC 704/500

(57) ABSTRACT

An audio encoding apparatus is provided that includes a transform unit to transform an audio signal in the time domain into an audio spectrum in the frequency domain; a bit allocation unit to determine the number of allocated bits by using spectral energy in predetermined frequency band units for the audio spectrum; and an encoding unit to determine the number of unit magnitude pulses for factorial pulse coding based on the number of allocated bits for the audio spectrum and to perform factorial pulse coding in the frequency band units for the audio spectrum by using the determined number of unit magnitude pulses.

### CROSS-REFERENCE TO RELATED PATENT APPLICATION

This application claims the benefit of Russian Patent Application No. RU2012103446, filed on Feb. 2, 2012, in the Russian Patent Office and U.S. Provisional Application No. 61/595,760, filed on Feb. 7, 2012, in the U.S. Patent Office, the disclosures of which are incorporated by reference herein in their entirety.

### BACKGROUND

1. Field

Apparatuses, devices, and articles of manufacture consistent with the present disclosure relate to audio encoding and decoding, and more particularly, to a method and apparatus for processing audio signals at low complexity.

2. Description of the Related Art

In factorial pulse coding or decoding of audio signals, to determine a value m corresponding to the number of unit magnitude pulses from the number b of bits required for each frequency band, a method of presetting an arbitrary maximum value which m can have and finding the value m according to b while iteratively increasing the value of m from 0 to the preset maximum value by 1 has been used. However, such an iterative method has high complexity when a length of a frequency band is long or a range of values of m is great.

### SUMMARY

It is an aspect to provide a method and apparatus for determining the number of unit magnitude pulses at low complexity in correspondence with the number of bits allocated to each frequency band to apply factorial pulse coding for each frequency band unit, and a multimedia device employing the same.

According to an aspect of one or more exemplary embodiments, there is provided a spectrum encoding method including: determining a number of unit magnitude pulses for factorial pulse coding based on a number of allocated bits in frequency band units for a spectrum; and performing factorial pulse coding in the frequency band units for the spectrum by using the determined number of unit magnitude pulses.

According to another aspect of one or more exemplary embodiments, there is provided an audio encoding apparatus including: a transform unit to transform an audio signal in a time domain to an audio spectrum in a frequency domain; a bit allocation unit to determine a number of allocated bits by using spectral energy in predetermined frequency band units for the audio spectrum; and an encoding unit to determine the number of unit magnitude pulses for factorial pulse coding based on the number of allocated bits for the audio spectrum and to perform factorial pulse coding in the frequency band units for the audio spectrum by using the determined number of unit magnitude pulses.

According to another aspect of one or more exemplary embodiments, there is provided a spectrum decoding method including: determining a number of unit magnitude pulses for factorial pulse coding based on a number of allocated bits in frequency band units for a spectrum; and performing factorial pulse decoding in the frequency band units for the spectrum by using the determined number of unit magnitude pulses.

According to another aspect of one or more exemplary embodiments, there is provided an audio decoding apparatus including: a bit allocation unit to determine a number of allocated bits by using spectral energy in predetermined frequency band units for an audio spectrum included in a bitstream; a decoding unit to determine a number of unit magnitude pulses for factorial pulse decoding based on the number of allocated bits in frequency band units for the audio spectrum and to perform factorial pulse decoding in the frequency band units for the audio spectrum by using the determined number of unit magnitude pulses; and an inverse transform unit to transform the audio spectrum decoded by the decoding unit to an audio signal in a time domain.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an audio encoding apparatus according to an exemplary embodiment;

FIG. 2 is a block diagram of a bit allocation unit in the audio encoding apparatus of FIG. 1, according to an exemplary embodiment;

FIG. 3 is a block diagram of a bit allocation unit in the audio encoding apparatus of FIG. 1, according to another exemplary embodiment;

FIG. 4 is a block diagram of a bit allocation unit in the audio encoding apparatus of FIG. 1, according to another exemplary embodiment;

FIG. 5 is a block diagram of an encoding unit in the audio encoding apparatus of FIG. 1, according to an exemplary embodiment;

FIG. 6 is a block diagram of an audio encoding apparatus according to another exemplary embodiment;

FIG. 7 is a block diagram of an audio decoding apparatus according to an exemplary embodiment;

FIG. 8 is a block diagram of a bit allocation unit in the audio decoding apparatus of FIG. 7, according to an exemplary embodiment;

FIG. 9 is a block diagram of a decoding unit in the audio decoding apparatus of FIG. 7, according to an exemplary embodiment;

FIG. 10 is a block diagram of a decoding unit in the audio decoding apparatus of FIG. 7, according to another exemplary embodiment;

FIG. 11 is a block diagram of a decoding unit in the audio decoding apparatus of FIG. 7, according to another exemplary embodiment;

FIG. 12 is a block diagram of an audio decoding apparatus according to another exemplary embodiment;

FIG. 13 is a block diagram of an audio decoding apparatus according to another exemplary embodiment;

FIG. 14 is a flowchart illustrating a factorial pulse coding method according to an exemplary embodiment;

FIG. 15 is a flowchart illustrating a method of determining a number m of unit magnitude pulses satisfying an allocated number b of bits in frequency band units, according to an exemplary embodiment;

FIG. 16 is a flowchart illustrating a method of determining a number m of unit magnitude pulses satisfying an allocated number b of bits in frequency band units, according to another exemplary embodiment;

FIG. 17 is a flowchart illustrating a method of determining a number m of unit magnitude pulses satisfying an allocated number b of bits in frequency band units, according to another exemplary embodiment;

FIG. 18 is a block diagram of a multimedia device including an encoding module, according to an exemplary embodiment;

FIG. 19 is a block diagram of a multimedia device including a decoding module, according to an exemplary embodiment; and

FIG. 20 is a block diagram of a multimedia device including an encoding module and a decoding module, according to an exemplary embodiment.

### DETAILED DESCRIPTION

The present inventive concept may allow various kinds of change or modification and various changes in form, and specific exemplary embodiments will be illustrated in drawings and described in detail in the specification. However, it should be understood that the specific exemplary embodiments do not limit the present inventive concept to a specific disclosing form but include every modified, equivalent, or replaced one within the spirit and technical scope of the present inventive concept. In the following description, well-known functions or constructions are not described in detail since they would obscure the invention with unnecessary detail.

Although terms, such as ‘first’ and ‘second’, can be used to describe various elements, the elements cannot be limited by the terms. The terms can be used to classify a certain element from another element.

The terminology used in the application is used only to describe specific exemplary embodiments and does not have any intention to limit the present inventive concept. Although general terms as currently widely used as possible are selected as the terms used in the present inventive concept while taking functions in the present inventive concept into account, they may vary according to an intention of those of ordinary skill in the art, judicial precedents, or the appearance of new technology. In addition, in specific cases, terms intentionally selected by the applicant may be used, and in this case, the meaning of the terms will be disclosed in corresponding description of the invention. Accordingly, the terms used in the present inventive concept should be defined not by simple names of the terms but by the meaning of the terms and the content over the present inventive concept.

An expression in the singular includes an expression in the plural unless they are clearly different from each other in a context. In the application, it should be understood that terms, such as ‘include’ and ‘have’, are used to indicate the existence of implemented feature, number, step, operation, element, part, or a combination of them without excluding in advance the possibility of existence or addition of one or more other features, numbers, steps, operations, elements, parts, or combinations of them.

Hereinafter, the present inventive concept will be described more fully with reference to the accompanying drawings, in which exemplary embodiments are shown. Like reference numerals in the drawings denote like elements, and thus their repetitive description will be omitted.

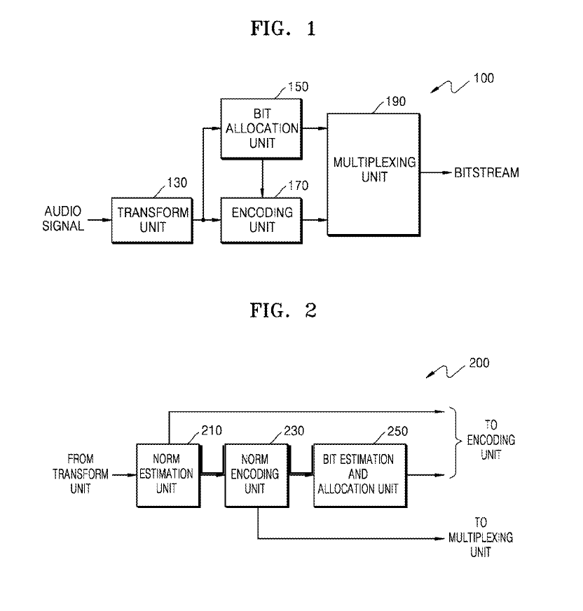

FIG. 1 is a block diagram of an audio encoding apparatus 100 according to an exemplary embodiment.

The audio encoding apparatus 100 shown in FIG. 1 may include a transform unit 130, a bit allocation unit 150, an encoding unit 170, and a multiplexing unit 190. The components may be integrated in at least one module and be implemented as at least one processor (not shown). The term “audio” may indicate music, voice, or a mixed signal of music and voice.

Referring to FIG. 1, the transform unit 130 may generate an audio spectrum by transforming an audio signal in the time domain to the audio spectrum in the frequency domain. The time-frequency domain transform may be performed using various well-known methods, such as a discrete cosine transform (DCT).

The bit allocation unit 150 may determine the number of allocated bits in each sub-band unit for the audio spectrum by using a masking threshold value, which is obtained using spectral energy or a psychoacoustic model, and the spectral energy. The term “sub-band” may indicate a unit of grouping samples of an audio spectrum and may have a uniform or non-uniform length by reflecting a critical band. In the case of non-uniform length, sub-bands may be set so that the number of samples included in each sub-band gradually increases from a first sample of one frame to the last sample of the same frame. Herein, the number of sub-bands included in one frame or the number of samples included in the sub-bands may be determined in advance. Alternatively, after one frame is divided into a predetermined number of sub-bands having a uniform length, lengths of the sub-bands may be adjusted according to a distribution of spectral coefficients. The distribution of spectral coefficients may be determined using a spectral flatness measure, a difference between a maximum value and a minimum value, a differential value of the maximum value, or the like.

According to an embodiment, the bit allocation unit 150 may estimate the number of allowable bits by using a Norm value, e.g., a mean spectral energy, obtained in each sub-band unit, allocate bits by using the mean spectral energy, and limit the number of allocated bits not to exceed the number of allowable bits. According to another embodiment, the bit allocation unit 150 may estimate the number of allowable bits in each sub-band unit by using a psychoacoustic model, allocate bits by using the mean spectral energy, and limit the number of allocated bits not to exceed the number of allowable bits.

The encoding unit 170 may generate information regarding an encoded spectrum by quantizing and lossless encoding the audio spectrum based on the finally determined number of allocated bits in each sub-band unit.

The multiplexing unit 190 may generate a bitstream by multiplexing the Norm value provided by the bit allocation unit 150 and the information regarding the encoded spectrum provided by the encoding unit 170.

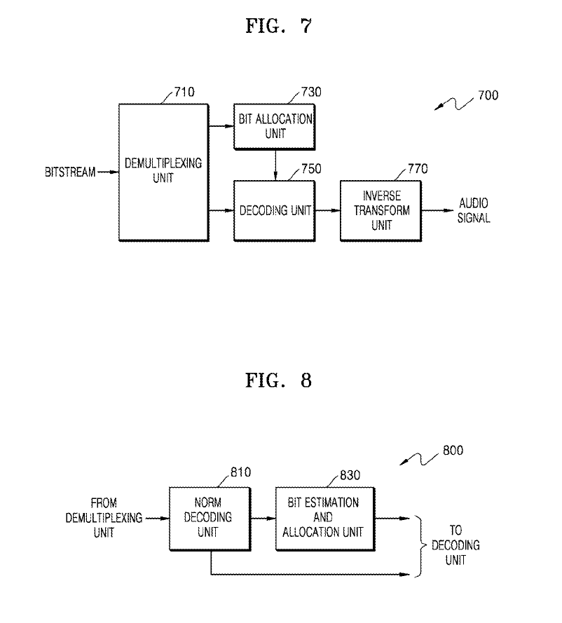

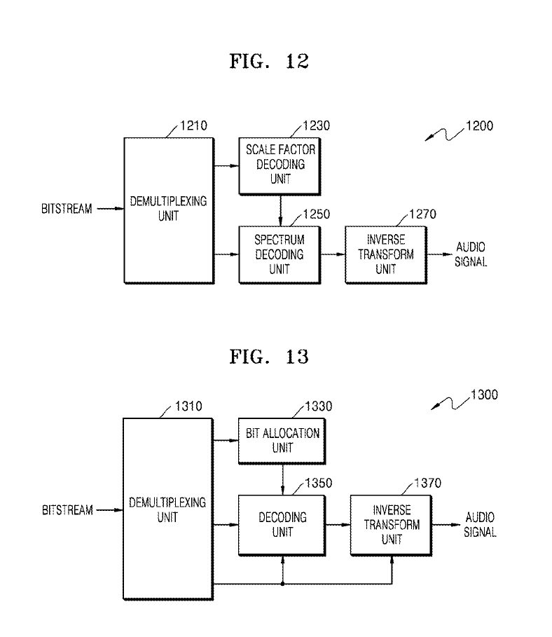

The audio encoding apparatus 100 may generate a noise level for a given sub-band and provide the generated noise level to an audio decoding apparatus (700 of FIG. 7, 1200 of FIG. 12, or 1300 of FIG. 13).

FIG. 2 is a block diagram of a bit allocation unit 200 in the audio encoding apparatus 100 of FIG. 1, according to an exemplary embodiment.

The bit allocation unit 200 shown in FIG. 2 may include a Norm estimation unit 210, a Norm encoding unit 230, and a bit estimation and allocation unit 250. The components may be integrated in at least one module and be implemented as at least one processor (not shown).

Referring to FIG. 2, the Norm estimation unit 210 may obtain a Norm value corresponding to mean spectral energy in each sub-band unit. At this time, the Norm value may be calculated using, for example, the same method as in ITU-T G.719, but the calculating method is not limited thereto. The Norm value obtained for each sub-band unit may be provided to the encoding unit 150.

The Norm encoding unit 230 may quantize and lossless encode the Norm value obtained for each sub-band unit. The Norm value quantized in each sub-band unit may be provided to the bit estimation and allocation unit 250, or a Norm value dequantized again in each sub-band unit may be provided to the bit estimation and allocation unit 250. The Norm value quantized and lossless-encoded in each sub-band unit may be provided to the multiplexing unit 190.

The bit estimation and allocation unit 250 may estimate and allocate the required number of bits by using the Norm value in each sub-band unit. Preferably, a dequantized Norm value may be used so that the same bit estimation and allocation process can be used in an encoding part and a decoding part. At this time, a Norm value adjusted by taking a masking effect into account may be used. For the adjustment of a Norm value, for example, psychoacoustic weighting applied in ITU-T G.719 may be used, but the adjustment of a Norm value is not limited thereto.

The bit estimation and allocation unit 250 may calculate a masking threshold value by using the Norm value in each sub-band unit and estimate the number of perceptually required bits by using the masking threshold value. Various well-known methods may be used for obtaining a masking threshold value by using spectral energy. That is, the masking threshold value is a value corresponding to just noticeable distortion (JND), and when quantization noise is less than the masking threshold value, perceptual noise cannot be perceived. Thus, the number of minimum bits required not to perceive perceptual noise may be calculated using the masking threshold value. According to another embodiment, the number of bits satisfying the masking threshold value may be estimated by calculating a signal-to-mask ratio (SMR) by using a ratio of the Norm value to the masking threshold value in each sub-band unit and by using a relationship of 6.025 dB≈1 bit for the SMR. Although the number of estimated bits is the number of minimum bits required not to perceive perceptual noise, since more than the number of estimated bits does not have to be used in terms of compression, the number of estimated bits may be considered as the number of maximum bits allowed in sub-band units (hereinafter, referred to as the number of allowable bits). At this time, the number of allowable bits for each sub-band may be represented in an integer unit or a decimal point unit.

According to an embodiment, the bit estimation and allocation unit 250 may perform bit allocation of a decimal point unit by using the Norm value in each sub-band unit. At this time, bits are sequentially allocated from a sub-band having a greater Norm value, and more bits may be allocated to a perceptually important sub-band by weighting a Norm value of each sub-band according to a perceptual importance of each sub-band. The perceptual importance may be determined through, for example, psychoacoustic weighting as in ITU-T G.719.

In detail, the bit estimation and allocation unit 250 may sequentially allocate bits for each sample from a sub-band having a greater Norm value. That is, first of all, bits per sample are allocated to a sub-band having the maximum Norm value, and the Norm value of the sub-band for which bits have been allocated is decreased by a predetermined unit, and priority is changed so that bits are allocated to another sub-band. This process may be repeated until a number B of whole bits usable in a given frame is fully allocated.

The bit estimation and allocation unit 250 may determine the number of finally allocated bits by limiting the number of allocated bits for each sub-band not to exceed the number of estimated bits, i.e., the number of allowable bits. For all sub-bands, the number of allocated bits is compared with the number of estimated bits, and if the number of allocated bits is greater than the number of estimated bits, the number of allocated bits is limited to the number of estimated bits. As a result of the bit number limitation, if the number of bits for the whole sub-bands of the given frame is less than the number B of whole bits usable in the given frame, bits corresponding to the difference may be uniformly distributed to the whole sub-bands or non-uniformly distributed according to perceptual importance.

Accordingly, since the number of bits of each sub-band can be determined with a decimal point unit and limited to the number of allowable bits, the number of whole bits of a given frame may be efficiently distributed.

A mathematical equation may be used to estimate and allocate the number of bits required for each sub-band. For example, the number of allocated bits per sample of each sub-band for maximizing a signal-to-noise ratio (SNR) of an input spectrum may be estimated within a range of the number B of whole bits usable in a given frame based on a solution for optimizing quantization distortion and the number of bits allocated to each sub-band. Accordingly, since the number of allocated bits in each sub-band unit can be determined at once without repeating several times, complexity can be lowered.

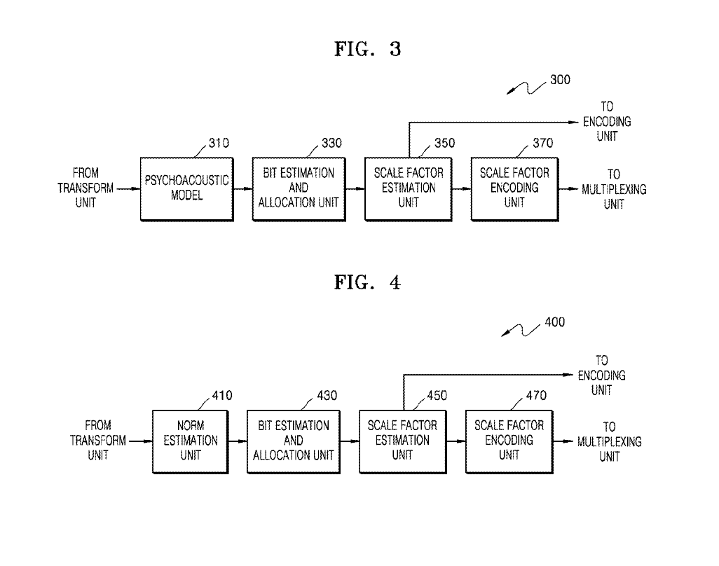

FIG. 3 is a block diagram of a bit allocation unit 300 in the audio encoding apparatus 100 of FIG. 1, according to another exemplary embodiment.

The bit allocation unit 300 shown in FIG. 3 may include a psychoacoustic model 310, a bit estimation and allocation unit 330, a scale factor estimation unit 350, and a scale factor encoding unit 370. The components may be integrated in at least one module and be implemented as at least one processor (not shown).

Referring to FIG. 3, the psychoacoustic model 310 may obtain a masking threshold value for each sub-band by receiving the audio spectrum provided by the transform unit 130.

The bit estimation and allocation unit 330 may estimate the number of perceptually required bits by using the masking threshold value in each sub-band unit. That is, an SMR may be obtained in each sub-band unit, and the number of bits satisfying the masking threshold value may be estimated by using the relationship 6.025 dB≈1 bit for the SMR. Although the number of estimated bits is the number of minimum bits required not to perceive perceptual noise, since more bits than the number of estimated bits do not have to be used in terms of compression, the number of estimated bits may be considered as the number of maximum bits allowed in sub-band units (hereinafter, referred to as the number of allowable bits). At this time, the bit estimation and allocation unit 330 may perform bit allocation with a decimal point unit by using spectral energy in each sub-band unit.

For the whole sub-bands, the bit estimation and allocation unit 330 may compare the number of allocated bits with the number of estimated bits and limit the number of allocated bits to the number of estimated bits if the number of allocated bits is greater than the number of estimated bits. As a result of the bit number limitation, if the number of bits for the whole sub-bands of a given frame is less than the number B of whole bits usable in the given frame, bits corresponding to the difference may be uniformly distributed to the whole sub-bands or non-uniformly distributed according to perceptual importance.

The scale factor estimation unit 350 may estimate a scale factor by using the number of allocated bits that is finally determined in each sub-band unit. The scale factor estimated in each sub-band unit may be provided to the encoding unit 170.

The scale factor encoding unit 370 may quantize and lossless encode the scale factor estimated in each sub-band unit. The scale factor encoded in each sub-band unit may be provided to the multiplexing unit 190.

FIG. 4 is a block diagram of a bit allocation unit 400 in the audio encoding apparatus 100 of FIG. 1, according to another exemplary embodiment.

The bit allocation unit 400 shown in FIG. 4 may include a Norm estimation unit 410, a bit estimation and allocation unit 430, a scale factor estimation unit 450, and a scale factor encoding unit 470. The components may be integrated in at least one module and be implemented as at least one processor (not shown).

Referring to FIG. 4, the Norm estimation unit 410 may obtain a Norm value corresponding to mean spectral energy in each sub-band unit.

The bit estimation and allocation unit 430 may obtain a masking threshold value by using spectral energy and estimate the number of perceptually required bits, i.e., the number of allowable bits, by using the masking threshold value in each sub-band unit.

The bit estimation and allocation unit 430 may perform bit allocation with an integer unit or a decimal point unit by using the spectral energy in each sub-band unit.

For the whole sub-bands, the bit estimation and allocation unit 430 compares the number of allocated bits with the number of estimated bits and limits the number of allocated bits to the number of estimated bits if the number of allocated bits is greater than the number of estimated bits. As a result of the bit number limitation, if the number of allocated bits for the whole sub-bands of a given frame is less than the number B of whole bits usable in the given frame, bits corresponding to the difference may be uniformly distributed to the whole sub-bands or non-uniformly distributed according to the perceptual importance.

The scale factor estimation unit 450 may estimate a scale factor by using the number of allocated bits that is finally determined in each sub-band unit. The scale factor estimated in each sub-band unit may be provided to the encoding unit 170.

The scale factor encoding unit 470 may quantize and lossless encode the scale factor estimated in each sub-band unit. The scale factor encoded in each sub-band unit may be provided to the multiplexing unit 190.

FIG. 5 is a block diagram of an encoding unit 500 in the audio encoding apparatus 100 of FIG. 1, according to an exemplary embodiment.

The encoding unit 500 shown in FIG. 5 may include a spectrum normalization unit 510 and a spectrum encoding unit 530 that may be integrated in at least one module and be implemented as at least one processor (not shown). The spectrum normalization unit 510 may be optional.

Referring to FIG. 5, the spectrum normalization unit 510 may normalize the audio spectrum by using the Norm value of each sub-band provided by the bit allocation unit 150.

The spectrum encoding unit 530 may quantize the normalized audio spectrum by using the number of allocated bits of each sub-band and lossless encode the quantized result. For example, factorial pulse coding may be used for the spectrum encoding, but the embodiment is not limited thereto. According to factorial pulse coding, information, such as a position of a pulse, a magnitude of the pulse, and a sign of the pulse, within a range of the number of allocated bits may be represented in a factorial form.

The spectral information encoded by the spectrum encoding unit 530 may be provided to the multiplexing unit 190.

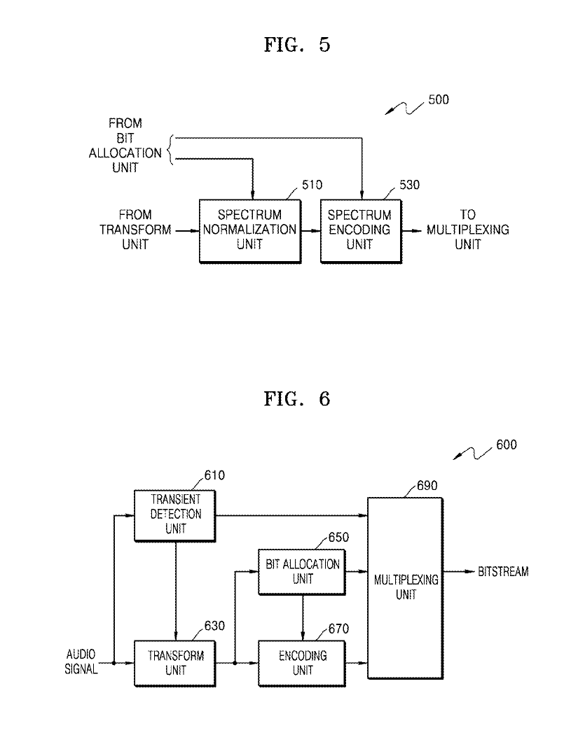

FIG. 6 is a block diagram of an audio encoding apparatus 600 according to another exemplary embodiment.

The audio encoding apparatus 600 shown in FIG. 6 may include a transient detection unit 610, a transform unit 630, a bit allocation unit 650, an encoding unit 670, and a multiplexing unit 690. The components may be integrated in at least one module and be implemented as at least one processor (not shown). Comparing with the audio encoding apparatus 100 of FIG. 1, the audio encoding apparatus 600 of FIG. 6 further includes the transient detection unit 610, and thus, a detailed description of the common components is omitted.

Referring to FIG. 6, the transient detection unit 610 may detect a period in which an audio signal has a transient characteristic. Various well-known methods may be used to detect the transient period. Transient signaling information provided by the transient detection unit 610 may be included in a bitstream by the multiplexing unit 690.

The transform unit 630 may determine a window size to be used for a transform according to a result of the transient period detection and perform a time-frequency domain transform based on the determined window size. For example, a short window may be applied to a sub-band in which a transient period is detected, and a long window may be applied to a sub-band in which a transient period is not detected.

The bit allocation unit 650 may be implemented by using any one of the bit allocation units 200, 300, and 400 shown in FIGS. 2 to 4.

The encoding unit 670 may determine a window size to be used for encoding according to a result of the transient period detection, similar to the transform unit 630.

The audio encoding apparatus 600 may generate a noise level for a sub-band and provide the generated noise level to an audio decoding apparatus (700 of FIG. 7, 1200 of FIG. 12, or 1300 of FIG. 13).

FIG. 7 is a block diagram of an audio decoding apparatus 700 according to an exemplary embodiment.

The audio decoding apparatus 700 shown in FIG. 7 may include a demultiplexing unit 710, a bit allocation unit 730, a decoding unit 750, and an inverse transform unit 770. The components may be integrated in at least one module and be implemented as at least one processor (not shown).

Referring to FIG. 7, the demultiplexing unit 710 may extract a quantized and lossless-encoded Norm value and information regarding an encoded spectrum by demultiplexing a bitstream.

The bit allocation unit 730 may obtain a dequantized Norm value from the quantized and lossless-encoded Norm value and determine the number of allocated bits by using the dequantized Norm value. The bit allocation unit 730 may operate substantially the same as the bit allocation unit 150 or 650 of the audio encoding apparatus 100 or 600. When the Norm value was adjusted through psychoacoustic weighting by the audio encoding apparatus 100 or 600, the dequantized Norm value may also be adjusted in the same manner by the audio decoding apparatus 700.

The decoding unit 750 may lossless decode and dequantize the encoded spectrum by using the information regarding the encoded spectrum, which is provided by the demultiplexing unit 710. For example, factorial pulse decoding may be used for the spectrum decoding.

The inverse transform unit 770 may generate a reconstructed audio signal by transforming the decoded spectrum into an audio signal in the time domain.

FIG. 8 is a block diagram of a bit allocation unit 800 in the audio decoding apparatus 700 of FIG. 7, according to an exemplary embodiment.

The bit allocation unit 800 shown in FIG. 8 may include a Norm decoding unit 810 and a bit estimation and allocation unit 830. The components may be integrated in at least one module and be implemented as at least one processor (not shown).

Referring to FIG. 8, the Norm decoding unit 810 may obtain a dequantized Norm value from the quantized and lossless-encoded Norm value provided by the demultiplexing unit 710.

The bit estimation and allocation unit 830 may determine the number of allocated bits by using the dequantized Norm value. In detail, the bit estimation and allocation unit 830 may obtain a masking threshold value by using spectral energy, i.e., a Norm value, in each sub-band unit and predict the number of perceptually required bits, i.e., the number of allowable bits, by using the masking threshold value. The bit estimation and allocation unit 830 may perform bit allocation with an integer unit or a decimal point unit by using spectral energy, i.e., a Norm value, in each sub-band unit.

For the whole sub-bands, the bit estimation and allocation unit 830 may compare the number of allocated bits with the number of estimated bits and limits the number of allocated bits to the number of estimated bits if the number of allocated bits is greater than the number of estimated bits. As a result of the bit number limitation, if the number of allocated bits for the whole sub-bands of a given frame is less than the number B of whole bits usable in the given frame, bits corresponding to the difference may be uniformly distributed to the whole sub-bands or non-uniformly distributed according to perceptual importance.

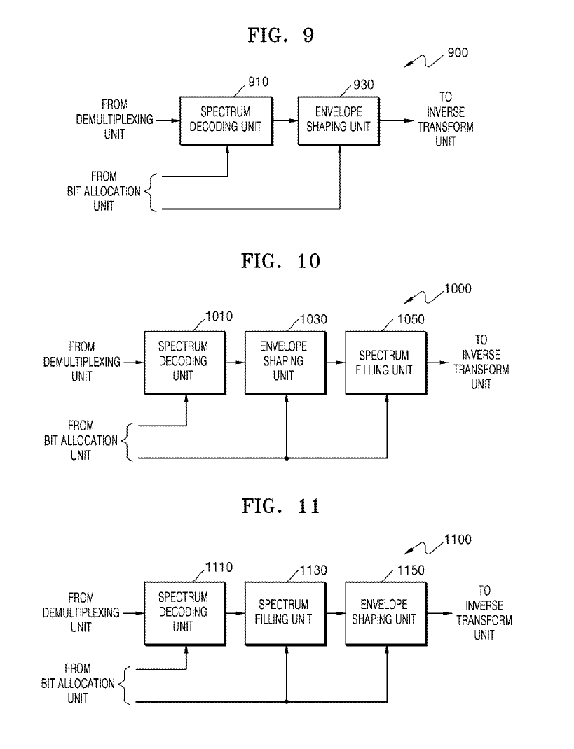

FIG. 9 is a block diagram of a decoding unit 900 in the audio decoding apparatus 700 of FIG. 7, according to an exemplary embodiment.

The decoding unit 900 shown in FIG. 9 may include a spectrum decoding unit 910 and an envelope shaping unit 930. The components may be integrated in at least one module and be implemented as at least one processor (not shown). The envelope shaping unit 930 may be optional according to a corresponding encoding apparatus.

Referring to FIG. 9, the spectrum decoding unit 910 may lossless decode and dequantize the encoded spectrum by using the information regarding the encoded spectrum, which is provided by the demultiplexing unit 710, and the number of allocated bits, which is provided by the bit allocation unit 730. The decoded spectrum provided by the spectrum decoding unit 910 may be a normalized spectrum.

The envelope shaping unit 930 may reconstruct a spectrum before normalization by envelope-shaping the normalized spectrum provided by the spectrum decoding unit 910 by using the dequantized Norm value provided by the bit allocation unit 730.

FIG. 10 is a block diagram of a decoding unit 1000 in the audio decoding apparatus 700 of FIG. 7, according to another exemplary embodiment.

The decoding unit 1000 shown in FIG. 10 may include a spectrum decoding unit 1010, an envelope shaping unit 1030, and a spectrum filling unit 1050. The components may be integrated in at least one module and be implemented as at least one processor (not shown). Comparing with the decoding unit 900 of FIG. 9, the decoding unit 1000 of FIG. 10 further includes the spectrum filling unit 1050, and thus, a detailed description of the common components is omitted. The spectrum filling unit 1050 may be optional according to the usage of a device equipped with the decoding unit 1000.

Referring to FIG. 10, when a sub-band including a portion dequantized to 0 exists in a spectrum provided by the envelope shaping unit 1030, the spectrum filling unit 1050 may fill the sub-band with a noise component. According to an embodiment, a noise component may be generated randomly or by copying a spectrum of a sub-band dequantized to non-zero. According to another embodiment, a noise component may be generated for a sub-band including a portion dequantized to 0, and energy of the noise component may be adjusted by using a ratio of the energy of the noise component to the dequantized Norm value, i.e., spectral energy, provided by the bit allocation unit 730. According to another embodiment, a noise component may be generated for a sub-band including a portion dequantized to 0 and may be adjusted so that mean energy of the noise component is 1. According to another embodiment, a noise level is received in each sub-band unit from the audio encoding apparatus 100 or 600, and when a given sub-band includes a portion dequantized to 0, a noise component may be generated for the given sub-band, and energy of the noise component may be adjusted by using the received noise level.

FIG. 11 is a block diagram of a decoding unit 1100 in the audio decoding apparatus 700 of FIG. 7, according to another exemplary embodiment.

The decoding unit 1100 shown in FIG. 11 may include a spectrum decoding unit 1110, a spectrum filling unit 1130, and an envelope shaping unit 1150. The components may be integrated in at least one module and be implemented as at least one processor (not shown). In comparison to the decoding unit 1000 of FIG. 10, the decoding unit 1100 of FIG. 11 has a different arrangement order of the spectrum filling unit 1130 and the envelope shaping unit 1150, and thus, a detailed description of the common components is omitted.

Referring to FIG. 11, when a sub-band including a portion dequantized to 0 exists in a normalized spectrum provided by the spectrum decoding unit 1110, the spectrum filling unit 1130 may fill the sub-band with a noise component. At this time, the various noise filling methods applied in relation to the spectrum filling unit 1050 of FIG. 10 may be used. Preferably, a noise component may be generated for a sub-band including a portion dequantized to 0 and may be adjusted so that mean energy of the noise component is 1.

The envelope shaping unit 1150 may reconstruct a spectrum before normalization for the spectrum including the sub-band filled with the noise component by using the dequantized Norm value provided by the bit allocation unit 730.

FIG. 12 is a block diagram of an audio decoding apparatus 1200 according to another exemplary embodiment.

The audio decoding apparatus 1200 shown in FIG. 12 may include a demultiplexing unit 1210, a scale factor decoding unit 1230, a spectrum decoding unit 1250, and an inverse transform unit 1270. The components may be integrated in at least one module and be implemented as at least one processor (not shown).

Referring to FIG. 12, the demultiplexing unit 1210 may extract a quantized and lossless-encoded scale factor and information regarding an encoded spectrum by demultiplexing a bitstream.

The scale factor decoding unit 1230 may lossless decode and dequantize the quantized and lossless-encoded scale factor in each sub-band unit.

The spectrum decoding unit 1250 may lossless decode and dequantize the encoded spectrum by using the information regarding the encoded spectrum, which is provided by the demultiplexing unit 1210, and the dequantized scale factor. The spectrum decoding unit 1250 may include the same components as the decoding unit 1000 of FIG. 10.

The inverse transform unit 1270 may generate a restored audio signal by transforming the spectrum decoded by the spectrum decoding unit 1250 to an audio signal in the time domain.

FIG. 13 is a block diagram of an audio decoding apparatus 1300 according to another exemplary embodiment.

The audio decoding apparatus 1300 shown in FIG. 13 may include a demultiplexing unit 1310, a bit allocation unit 1330, a decoding unit 1350, and an inverse transform unit 1370. The components may be integrated in at least one module and be implemented as at least one processor (not shown).

In comparison with the audio decoding apparatus 700 of FIG. 7, the audio decoding apparatus 1300 shown in FIG. 13 is different in that transient signaling information is provided to the decoding unit 1350 and the inverse transform unit 1370, and thus, a detailed description of the common components is omitted.

Referring to FIG. 13, the decoding unit 1350 may decode an encoded spectrum by using information regarding the encoded spectrum, which is provided by the demultiplexing unit 1310. At this time, a window size may vary according to transient signaling information.

The inverse transform unit 1370 may generate a reconstructed audio signal by transforming the decoded spectrum to an audio signal in the time domain. At this time, a window size may vary according to transient signaling information.

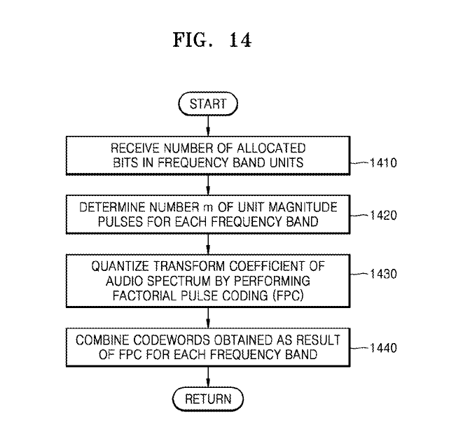

FIG. 14 is a flowchart illustrating a factorial pulse coding method according to an exemplary embodiment, which may preferably be performed by the encoding unit 170 of FIG. 1, the spectrum encoding unit 530 of FIG. 5, and the encoding unit 670 of FIG. 6.

Referring to FIG. 14, in operation 1410, the number of allocated bits is received in frequency band units, e.g., sub-band units. The number of allocated bits may be provided by the bit allocation unit 150 of FIG. 1.

In operation 1420, the number m of unit magnitude pulses may be determined for each frequency band based on the number of allocated bits.

In operation 1430, a transform coefficient of an audio spectrum may be quantized by performing factorial pulse coding based on the number m of unit magnitude pulses determined for each frequency band.

In operation 1440, codewords obtained as a result of factorial pulse coding for each frequency band may be combined. The combined codewords may be provided to the multiplexing unit 190 of FIG. 1 or 690 of FIG. 6.

The principle of factorial pulse coding will now be described.

Factorial pulse coding is a technique of efficiently coding a signal by using unit magnitude pulses and may represent the signal by using all combinations of the number of non-zero pulses, positions of the non-zero pulses, magnitudes of the non-zero pulses, and signs of the non-zero pulses. An occasional number N for all combinations capable of representing pulses may be expressed by Equation 1.

$$N = {\sum }_{i = 1}^{m} {2}^{i} F ( n , i ) D ( m , i ) \qquad ( 1 )$$

In Equation 1, 2ⁱ indicates an occasional number of occurrences of a sign for representing i non-zero pulses as + or −, F(n, i) indicates an occasional number of positions of the i non-zero pulses which can be selected for given n sample positions, and D(m, i) indicates an occasional number of occurrences of a signal selected at the positions of the i non-zero pulses, which can be represented by m unit magnitude pulses.

In Equation 1, F(n, i) and D(m, i) may be represented by Equations 2 and 3, respectively.

$$\begin{matrix}F ( n , i ) = {C}_{i}^{n} = \frac{n !}{i ! ( n - i ) !} & ( 2 ) \\ D ( m , i ) = {C}_{i - 1}^{m - 1} = \frac{( m - 1 ) !}{( i - 1 ) ! ( m - i ) !} & ( 3 )\end{matrix}$$

The number b of bits required to represent the occasional number N for all combinations, which is calculated by Equation 1, may be represented by Equation 4.

b=log₂ N (4)

Equation 4 may be arranged as in Equation 5.

$$b = {log}_{2} {\sum }_{i = 1}^{m} {2}^{i} \frac{n !}{i ! ( n - i ) !} \frac{( m - 1 ) !}{( i - 1 ) ! ( m - i ) !} \qquad ( 5 )$$

That is, the number b of bits required to perform factorial pulse coding for an input signal vector included in an arbitrary frequency band is defined by a complex polynomial expression of n corresponding to a band length and m corresponding to the number of unit magnitude pulses. In this case, since n is a given value, the polynomial expression can be considered as a correlation between m and b. To determine a value of m from b, since it is impossible to directly calculate the value of m from b by using Equation 5, a method of presetting an arbitrary maximum value which m can have and finding the value of m satisfying b while increasing the value of m from 0 to the preset maximum value by 1 is used. Since this iteration method has high complexity when a range of values of m is great, the complexity may be reduced by applying a binary search to the iteration method. The basic principle of factorial pulse coding is disclosed in U.S. Pat. No. 6,236,960.

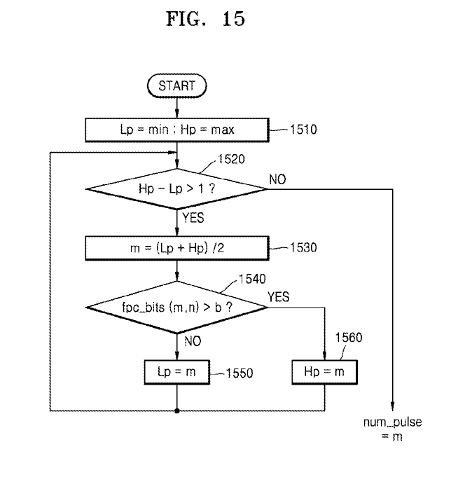

FIG. 15 is a flowchart illustrating a method of determining the number m of unit magnitude pulses satisfying the number b of allowable bits in frequency band units, according to an exemplary embodiment, in which a binary search is applied. In this case, it is assumed that the number b of bits required for factorial pulse coding increases with the number m of unit magnitude pulses. Referring to FIG. 15, in operation 1510, a minimum value Lp and a maximum value Hp which m can have may be set. The minimum value Lp and the maximum value Hp may be experimentally set to correspond to all frequency bands.

In operation 1520, it may be determined whether a difference between the minimum value Lp and the maximum value Hp is greater than 1. As a result of the determination in operation 1520, if the difference between the minimum value Lp and the maximum value Hp is equal to or less than 1, the final number num_pulse of unit magnitude pulses may be determined as a median m.

As a result of the determination in operation 1520, if the difference between the minimum value Lp and the maximum value Hp is greater than 1, a median m of the minimum value Lp and the maximum value Hp may be calculated in operation 1530.

In operation 1540, the number of bits required for factorial pulse coding with respect to the median m may be calculated and the number of calculated bits may be compared with a target value b. In operation 1540, fpc_bits(m,n) denotes a function for calculating the number of bits required for factorial pulse coding with respect to given values of m and n and corresponds to Equation 4.

As a result of the comparison in operation 1540, if the number of bits required for factorial pulse coding with respect to the median m is less than the target value b, a value greater than the median m may be required, and thus, the median m may be set as the minimum value Lp in operation 1550, and operation 1520 may be iteratively performed.

As a result of the comparison in operation 1540, if the number of bits required for factorial pulse coding with respect to the median m is greater than the target value b, a value less than the median m may be required, and thus, the median m may be set as the maximum value Hp in operation 1560, and operation 1520 may be iteratively performed.

In this case, when a maximum value in a range of values of m is MAX, the number of iterations may ┌log₂ MAX┐+1 at the most, and thus, the number of iterations may increase as the maximum value which m can have is large.

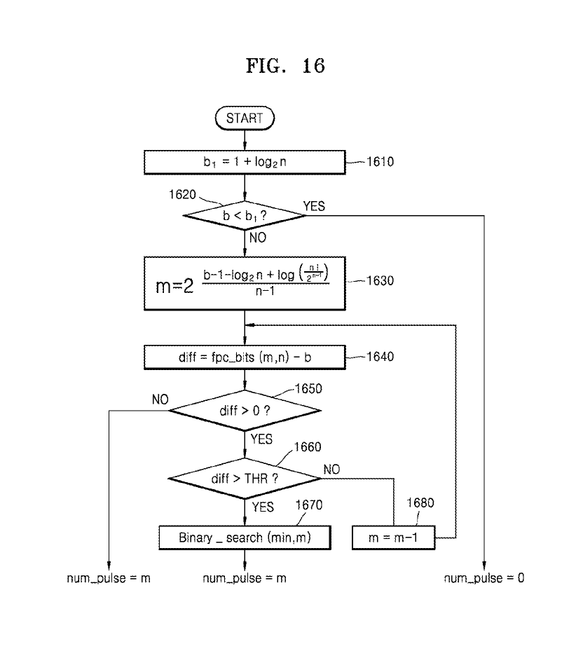

FIG. 16 is a flowchart illustrating a method of determining the number m of unit magnitude pulses satisfying the number b of allowable bits in frequency band units, according to another exemplary embodiment.

First, a process of determining a maximum value of the number m of unit magnitude pulses will be described.

In detail, Equation 5 may be equivalent to Equation 6.

$$b = 1 + {log}_{2} n + {log}_{2} z ( m , n ) \\ {log}_{2} ( m , n ) = 1 + {\sum }_{i = 1}^{min ( m , n ) - 1} {\prod }_{k = 1}^{i} 2 \frac{( m - k ) ( n - k )}{k ( k + 1 )} \qquad ( 6 )$$

In Equation 6, z(m, n) may be expanded in a polynomial expression as in Equation 7.

$$z ( m , n ) = {a}_{min ( m , n ) - 1} {m}^{min ( m , n ) - 1} + {a}_{min ( m , n ) - 2} {m}^{min ( m , n ) - 2} + … + {a}_{1} m + {a}_{0} , \\ {a}_{i} \geq 0 \qquad ( 7 )$$

When expansion is performed for the highest degree of m in Equation 7, Equation 6 may be represented by Equation 8.

$$b \geq 1 + {log}_{2} n + ( n - 1 ) {log}_{2} m - {log}_{2} ( \frac{n !}{{2}^{n - 1}} ) \qquad ( 8 )$$

When Equation 8 is rearranged for m, Equation 8 may be represented by Equation 9.

$$m \leq {2}^{\frac{b - 1 - {log}_{2} n + {log}_{2} ( \frac{n !}{{2}^{n - 1}} )}{n - 1}} \qquad ( 9 )$$

That is, Equation 9 exhibits a maximum value which the number m of unit magnitude pulses can have. The maximum value of m according to Equation 9 is a value closer to the final number of unit magnitude pulses than a maximum value arbitrarily determined in an initial stage, and a final value may be determined with much less iterations than existing methods. Here, the minimum value may be set as 0 or 1. Also, the minimum value may be determined as a natural number close to 0, through experiments or simulations in advance.

When Equation 8 is rearranged for m, Equation 8 may also be represented by Equation 10.

$${2}^{\frac{b - 1 - {log}_{2} n + {log}_{2} ( \frac{n !}{{2}^{n - 1}} )}{n - 1} -} - F ( n ) \leq m \leq {2}^{\frac{b - 1 - {log}_{2} n + {log}_{2} ( \frac{n !}{{2}^{n - 1}} )}{n - 1}} \qquad ( 10 )$$

In Equation 10, n denotes a length of a frequency band, b denotes the number of bits required to perform factorial pulse coding, m denotes the number of unit magnitude pulses, and F(n) denotes a function for determining a minimum value of the number of unit magnitude pulses, wherein F(n) may be determined according to a length of a frequency band, for example, determined as 2 when n is less than 9, 3 when n is less than 17, and 6 when n is less than 33. According to this, since a length of a frequency band is less than 17 in most cases, when a binary search method is used, the final number of unit magnitude pulses of each frequency band may be determined by performing a matching process once or twice.

Referring back to FIG. 16, in operation 1610, the number b₁ of bits required for coding at least one pulse for n input sample vectors in a predetermined frequency band may be calculated using Equation 11.

b₁=1+log₂ n (11)

In operation 1620, the number b of allocated bits given to the predetermined frequency band may be compared with the number b₁ of bits required for coding at least one pulse. As a result of the comparison in operation 1620, if the number b of allocated bits is less than the number b₁ of bits required for coding at least one pulse, the final number num_pulse of unit magnitude pulses is set as 0 without iterations.

In operation 1630, a maximum value of the number m of unit magnitude pulses may be acquired using Equation 9.

In operation 1640, the number of bits required for factorial pulse coding may be calculated using the maximum value of the number m of unit magnitude pulses, and a difference value diff between the number of bits required for factorial pulse coding and the number b of allocated bits may be acquired. In operation 1640, fpc_bits(m,n) denotes a function for calculating the number of bits required for factorial pulse coding with respect to given m and n.

In operation 1650, the difference value diff may be compared with 0. As a result of the comparison in operation 1650, if the difference value diff is equal to or less than 0, a corresponding value of m may be determined as the final number num_pulse of unit magnitude pulses.

As a result of the comparison in operation 1650, if the difference value diff is greater than 0, the difference value diff may be compared with a predefined threshold THR in operation 1660. The threshold THR may be determined as an optimal value through experiments or simulations.

As a result of the comparison in operation 1660, if the difference value diff is greater than the predefined threshold THR, a rough and final value of m may be determined using a binary search within a range of (min, m) in operation 1670. The method illustrated in FIG. 15 may be used for the binary search.

As a result of the comparison in operation 1660, if the difference value diff is equal to or less than the predefined threshold THR, the number of bits required for factorial pulse coding may be recalculated by decreasing a current value of m by 1, and a linear decrement process may be repeated until the number of used bits satisfies the number b of allocated bits. A fine and final value of m, which satisfies the number b of allocated bits may be determined as the number of unit magnitude pulses of a corresponding frequency band.

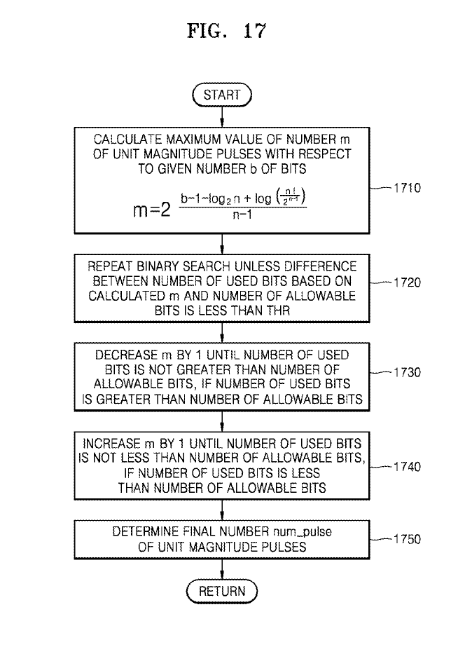

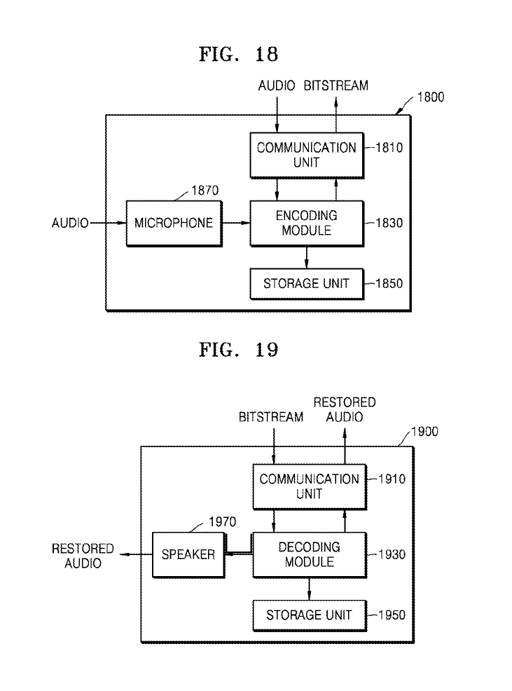

FIG. 17 is a flowchart illustrating a method of determining the number m of unit magnitude pulses satisfying the number b of allocated bits in frequency band units, according to another exemplary embodiment. Although not shown in FIG. 17, it is considered that operations 1610 and 1620 of FIG. 16 have been performed in advance.

Referring to FIG. 17, in operation 1710, if the number b of allocated bits is greater than the number b₁ of bits required for coding at least one pulse, a maximum value of the number m of unit magnitude pulses may be calculated using Equation 9.

In operation 1720, the number of bits required for factorial pulse coding may be calculated using the maximum value of the number m of unit magnitude pulses, and a difference value diff between the number of calculated bits and the number b of allocated bits, for example, an absolute value of the difference value diff may be compared with a predefined threshold THR. As in FIG. 16, the threshold THR may be determined as an optimal value through experiments or simulations. As a result of the comparison, if the difference value diff is greater than the threshold THR, a value of m may be changed by performing a binary search within a range of (min, m). The binary search process may be repeated unless a difference value diff between the number of bits, which is calculated using the changed value of m, and the number b of allocated bits is less than the threshold THR.

In operation 1730, when the difference value diff between the number of bits, which is calculated using the changed value of m, and the number b of allocated bits is less than the threshold THR, if the number of bits, which is calculated using the changed value of m, is greater than the number b of allocated bits, a current value of m may be decreased by 1 until the number b of allocated bits is satisfied. A value of m, which satisfies the number b of allocated bits, may be determined as the number of unit magnitude pulses of a corresponding frequency band.

In operation 1740, when the difference value diff between the number of bits, which is calculated using the changed value of m, and the number b of allocated bits is less than the threshold THR, if the number of bits, which is calculated using the changed value of m, is less than the number b of allocated bits, a current value of m may be increased by 1 until the allocated number b of bits is satisfied. A value of m, which satisfies the number b of allocated bits, may be determined as the number of unit magnitude pulses of a corresponding frequency band.

In conclusion, an approximate value of m may be determined by a binary search process and then a precise value of m may be determined by a linear decrement process.

According to the embodiments of the present invention, by using a mathematical equation to determine the maximum value of the number of unit magnitude pulses for each frequency band by selectively using a binary search between 1 and the maximum value and a linear decrement method to reduce the number of iterations, a method and apparatus for processing audio signal at low complexity can be realized. In addition, when the number of bits allocated to an arbitrary frequency band is less than the minimum number of bits required for coding one pulse, the number of unit magnitude pulses for the arbitrary frequency band is allocated to be 0, thereby reducing the processing complexity in an exceptional situation.

Table 1 illustrates a comparison of the number of iterations in a case of using a binary search method and a case of using a combination of the binary search method and a linear decrement method. It is assumed that a range of values which m can have is from 90 to 500.

TABLE 1

| | Mean number of iterations (counts) |
|---|---|
| Binary search method | 10.1 |
| Combination of binary search method | 1.9 |
| and linear decrement method | |

The factorial pulse coding methods of FIGS. 14 to 17 may be written a computer codes and performed by at least one processing device.

The factorial pulse coding methods of FIGS. 14 to 17 may be used by the encoding unit 170 of FIG. 1, the spectrum encoding unit 530 of FIG. 5, or the encoding unit 670 of FIG. 6, but the embodiment is not limited thereto.

The factorial pulse coding methods of FIGS. 14 to 17 may also be used for factorial pulse decoding by the decoding unit 750 of FIG. 7, the spectrum decoding unit 910 of FIG. 9, the spectrum decoding unit 1010 of FIG. 10, the spectrum decoding unit 1110 of FIG. 11, the spectrum decoding unit 1250 of FIG. 12, or the spectrum decoding unit 1350 of FIG. 13, but the embodiment is not limited thereto.

FIG. 18 is a block diagram of a multimedia device including an encoding module, according to an exemplary embodiment.

Referring to FIG. 18, the multimedia device 1800 may include a communication unit 1810 and the encoding module 1830. In addition, the multimedia device 1800 may further include a storage unit 1850 for storing an audio bitstream obtained as a result of encoding according to the usage of the audio bitstream. Moreover, the multimedia device 1800 may further include a microphone 1870. That is, the storage unit 1850 and the microphone 1870 may be optionally included. The multimedia device 1800 may further include an arbitrary decoding module (not shown), e.g., a decoding module for performing a general decoding function or a decoding module according to an exemplary embodiment. The encoding module 1830 may be implemented by at least one processor, e.g., a central processing unit (not shown) by being integrated with other components (not shown) included in the multimedia device 1800 as one body.

The communication unit 1810 may receive at least one of an audio signal or an encoded bitstream provided from the outside or transmit at least one of a restored audio signal or an encoded bitstream obtained as a result of encoding by the encoding module 1830.

The communication unit 1810 is configured to transmit and receive data to and from an external multimedia device through a wireless network, such as wireless Internet, wireless intranet, a wireless telephone network, a wireless Local Area Network (LAN), Wi-Fi, Wi-Fi Direct (WFD), third generation (3G), fourth generation (4G), Bluetooth, Infrared Data Association (IrDA), Radio Frequency Identification (RFID), Ultra WideBand (UWB), Zigbee, or Near Field Communication (NFC), or a wired network, such as a wired telephone network or wired Internet.

According to an exemplary embodiment, the encoding module 1830 may generate a bitstream by transforming an audio signal in the time domain, which is provided through the communication unit 1810 or the microphone 1870, to an audio spectrum in the frequency domain, determining the number of allocated bits by using spectral energy in predetermined frequency band units for the audio spectrum, determining a number of unit magnitude pulses for factorial pulse coding based on a number of allocated bits in frequency band units for the audio spectrum, and performing factorial pulse coding in the frequency band units for the spectrum by using the determined number of unit magnitude pulses.

According to another exemplary embodiment, the encoding module 1830 may estimate a maximum value of the number of unit magnitude pulses with respect to the number of allocated bits and determine the final number of unit magnitude pulses of each frequency band by performing a binary search within a range from a minimum value to the maximum value. According to another exemplary embodiment, the encoding module 1830 may estimate a maximum value of the number of unit magnitude pulses with respect to the number of allocated bits and determine the final number of unit magnitude pulses of each frequency band by selectively performing a binary search method and a linear decrement method within a range of a minimum value and the maximum value.

The storage unit 1850 may store the encoded bitstream generated by the encoding module 1830. In addition, the storage unit 1850 may store various programs required to operate the multimedia device 1800.

The microphone 1870 may provide an audio signal from a user or the outside to the encoding module 1830.

FIG. 19 is a block diagram of a multimedia device including a decoding module, according to an exemplary embodiment.

The multimedia device 1900 of FIG. 19 may include a communication unit 1910 and the decoding module 1930. In addition, according to the use of a restored audio signal obtained as a decoding result, the multimedia device 1900 of FIG. 19 may further include a storage unit 1950 for storing the restored audio signal. In addition, the multimedia device 1900 of FIG. 19 may further include a speaker 1970. That is, the storage unit 1950 and the speaker 1970 are optional. The multimedia device 1900 of FIG. 19 may further include an encoding module (not shown), e.g., an encoding module for performing a general encoding function or an encoding module according to an exemplary embodiment. The decoding module 1930 may be integrated with other components (not shown) included in the multimedia device 1900 and implemented by at least one processor, e.g., a central processing unit (CPU).

Referring to FIG. 19, the communication unit 1910 may receive at least one of an audio signal or an encoded bitstream provided from the outside or may transmit at least one of a restored audio signal obtained as a result of decoding of the decoding module 1930 or an audio bitstream obtained as a result of encoding. The communication unit 1910 may be implemented substantially and similarly to the communication unit 1810 of FIG. 18.

According to an exemplary embodiment, the decoding module 1930 may generate a restored audio signal by receiving a bitstream provided through the communication unit 1910, determining the number of allocated bits by using spectral energy in predetermined frequency band units for an audio spectrum in the bitstream, determining a number of unit magnitude pulses for factorial pulse coding based on a number of allocated bits in frequency band units for the audio spectrum, performing factorial pulse decoding in the frequency band units for the spectrum by using the determined number of unit magnitude pulses, and transforming the audio spectrum decoded by the decoding unit into an audio signal in the time domain

According to another exemplary embodiment, the decoding module 1930 may estimate a maximum value of the number of unit magnitude pulses with respect to the number of allocated bits and determine the final number of unit magnitude pulses of each frequency band by performing a binary search within a range from a minimum value to the maximum value. According to another exemplary embodiment, the decoding module 1930 may estimate a maximum value of the number of unit magnitude pulses with respect to the number of allocated bits and determine the final number of unit magnitude pulses of each frequency band by selectively using a binary search method and a linear decrement method with respect to a range from a minimum value to the maximum value.

The storage unit 1950 may store the restored audio signal generated by the decoding module 1930. In addition, the storage unit 1950 may store various programs required to operate the multimedia device 1900.

The speaker 1970 may output the restored audio signal generated by the decoding module 1930 to the outside.

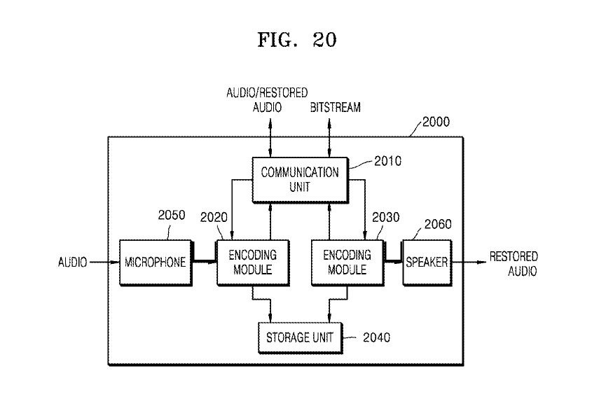

FIG. 20 is a block diagram of a multimedia device including an encoding module and a decoding module, according to an exemplary embodiment.

The multimedia device 2000 shown in FIG. 20 may include a communication unit 2010, an encoding module 2020, and a decoding module 2030. In addition, the multimedia device 2000 may further include a storage unit 2040 for storing an audio bitstream obtained as a result of encoding or a restored audio signal obtained as a result of decoding according to the usage of the audio bitstream or the restored audio signal. In addition, the multimedia device 2000 may further include a microphone 2050 and/or a speaker 2060. The encoding module 2020 and the decoding module 2030 may be implemented by at least one processor, e.g., a central processing unit (CPU) (not shown) by being integrated with other components (not shown) included in the multimedia device 2000 as one body.

Since the components of the multimedia device 2000 shown in FIG. 20 correspond to the components of the multimedia device 1800 shown in FIG. 18 or the components of the multimedia device 1900 shown in FIG. 19, a detailed description thereof is omitted.

Each of the multimedia devices 1800, 1900, and 2000 shown in FIGS. 18, 19, and 20 may include a voice communication only terminal, such as a telephone or a mobile phone, a broadcasting or music only device, such as a TV or an MP3 player, or a hybrid terminal device of a voice communication only terminal and a broadcasting or music only device but are not limited thereto. In addition, each of the multimedia devices 1800, 1900, and 2000 may be used as a client, a server, or a transducer displaced between a client and a server.

When the multimedia device 1800, 1900, or 2000 is, for example, a mobile phone, although not shown, the multimedia device 1800, 1900, or 2000 may further include a user input unit, such as a keypad, a display unit for displaying information processed by a user interface or the mobile phone, and a processor for controlling the functions of the mobile phone. In addition, the mobile phone may further include a camera unit having an image pickup function and at least one component for performing a function required for the mobile phone.

When the multimedia device 1800, 1900, or 2000 is, for example, a TV, although not shown, the multimedia device 1800, 1900, or 2000 may further include a user input unit, such as a keypad, a display unit for displaying received broadcasting information, and a processor for controlling all functions of the TV. In addition, the TV may further include at least one component for performing a function of the TV.

The methods according to the embodiments can be written as computer-executable programs and can be implemented in general-use digital computers that execute the programs by using a non-transitory computer-readable recording medium. In addition, data structures, program instructions, or data files, which can be used in the embodiments, can be recorded on a non-transitory computer-readable recording medium in various ways. The non-transitory computer-readable recording medium is any data storage device that can store data which can be thereafter read by a computer system. Examples of the non-transitory computer-readable recording medium include magnetic storage media, such as hard disks, floppy disks, and magnetic tapes, optical recording media, such as CD-ROMs and DVDs, magneto-optical media, such as optical disks, and hardware devices, such as ROM, RAM, and flash memory, specially configured to store and execute program instructions. In addition, the non-transitory computer-readable recording medium may be a transmission medium for transmitting signal designating program instructions, data structures, or the like. Examples of the program instructions may include not only mechanical language codes created by a compiler but also high-level language codes executable by a computer using an interpreter or the like.

While the present invention has been particularly shown and described with reference to the exemplary embodiments thereof, it will be understood by those of ordinary skill in the art that various changes in form and details may be made therein without departing from the spirit and scope of the present invention as defined by the following claims.

What is claimed is:

1. A spectrum encoding method comprising:
determining a number of unit magnitude pulses for factorial pulse coding based on a number of allocated bits in frequency band units for a spectrum; and
performing factorial pulse coding in the frequency band units for the spectrum by using the determined number of unit magnitude pulses.

2. The spectrum encoding method of claim 1, wherein the determining of the number of unit magnitude pulses comprises estimating a maximum value of the number of unit magnitude pulses with respect to the number of allocated bits and determining the final number of unit magnitude pulses of each frequency band by performing a binary search within a range from a minimum value to the maximum value.

3. The spectrum encoding method of claim 1, wherein the minimum value is 0.

4. The spectrum encoding method of claim 1, wherein the minimum value is a value obtained by subtracting a predetermined constant from the maximum value according to a length of a frequency band.

5. The spectrum encoding method of claim 1, wherein the determining of the number of unit magnitude pulses comprises estimating a maximum value of the number of unit magnitude pulses with respect to the number of allocated bits and determining the final number of unit magnitude pulses of each frequency band by selectively performing a binary search method and a linear decrement method within a range of a minimum value and the maximum value.

6. The spectrum encoding method of claim 5, wherein the minimum value is 0.

7. The spectrum encoding method of claim 5, wherein the minimum value is a value obtained by subtracting a predetermined constant from the maximum value according to a length of a frequency band.

8. The spectrum encoding method of claim 5, wherein one of a binary search method and a linear decrement method is used for a predetermined number of unit magnitude pulses by using a difference value between the number of bits required for factorial pulse coding and the number of allocated bits.

9. The spectrum encoding method of claim 1, wherein the number of unit magnitude pulses of a corresponding frequency band is allocated to be 0 when the number of allocated bits is less than the number of bits required for coding at least one pulse.

10. An audio encoding apparatus comprising:
a transform unit to transform an audio signal in a time domain into an audio spectrum in a frequency domain;
a bit allocation unit to determine a number of allocated bits by using spectral energy in predetermined frequency band units for the audio spectrum; and
an encoding unit to determine a number of unit magnitude pulses for factorial pulse coding based on the number of allocated bits for the audio spectrum and to perform factorial pulse coding in the frequency band units for the audio spectrum by using the determined number of unit magnitude pulses.

11. A spectrum decoding method comprising:
determining a number of unit magnitude pulses for factorial pulse coding based on a number of allocated bits in frequency band units for a spectrum; and
performing factorial pulse decoding in the frequency band units for the spectrum by using the determined number of unit magnitude pulses.

12. The spectrum decoding method of claim 11, wherein the determining of the number of unit magnitude pulses comprises estimating a maximum value of the number of unit magnitude pulses with respect to the number of allocated bits and determining the final number of unit magnitude pulses of each frequency band by performing a binary search within a range from a minimum value to the maximum value.

13. The spectrum decoding method of claim 11, wherein the minimum value is 0.

14. The spectrum decoding method of claim 11, wherein the minimum value is a value obtained by subtracting a predetermined constant from the maximum value according to a length of a frequency band.

15. The spectrum decoding method of claim 11, wherein the determining of the number of unit magnitude pulses comprises estimating a maximum value of the number of unit magnitude pulses with respect to the number of allocated bits and determining the final number of unit magnitude pulses of each frequency band by selectively using a binary search method and a linear decrement method with respect to a range from a minimum value to the maximum value.

16. The spectrum decoding method of claim 15, wherein the minimum value is 0.

17. The spectrum decoding method of claim 15, wherein the minimum value is a value obtained by subtracting a predetermined constant from the maximum value according to a length of a frequency band.

18. The spectrum decoding method of claim 15, wherein one of the binary search method and the linear decrement method is used for a predetermined number of unit magnitude pulses by using a difference value between the number of bits required for factorial pulse coding and the number of allocated bits.

19. The spectrum decoding method of claim 11, wherein the number of unit magnitude pulses of a corresponding frequency band is allocated to be 0 when the number of allocated bits is less than the number of bits required for coding at least one pulse.

20. An audio decoding apparatus comprising:
a bit allocation unit to determine a number of allocated bits by using spectral energy in predetermined frequency band units for an audio spectrum included in a bitstream;
a decoding unit to determine a number of unit magnitude pulses for factorial pulse decoding based on the number of allocated bits in frequency band units for the audio spectrum and to perform factorial pulse decoding in the frequency band units for the audio spectrum by using the determined number of unit magnitude pulses; and
an inverse transform unit to transform the audio spectrum decoded by the decoding unit into an audio signal in a time domain.

21. A non-transitory computer-readable storage medium having stored therein program instructions, which when executed by a computer, perform the method of claim 1.

22. A non-transitory computer-readable storage medium having stored therein program instructions, which when executed by a computer, perform the method of claim 11.
